(19) United States
(12) Patent Application Publication
(10) Pub. No.: US 2014/0119319 A1
(43) Pub. Date: May 1, 2014

(54) Apparatus and Method for Reactive Inter-Cell Interference Coordination

(71) Applicant: Jawad Manssour, Seoul (KR)

(72) Inventor: Jawad Manssour, Seoul (KR)

(73) Assignee: TELEFONAKTIEBOLAGET L M ERICSSON (PUBL), Stockholm (SE)

(21) Appl. No.: 14/130,724

(22) PCT Filed: Apr. 27, 2012
(86) PCT No.: PCT/SE2012/050443

§ 371 Date: Jan. 3, 2014

Related U.S. Application Data
(60) Provisional application No. 61/507,379, filed on Jul. 13, 2011.

(51) Int. Cl. H04L 5/00; H04W 72/08

(52) U.S. Cl. CPC H04L 5/0032; H04W 72/082
USPC 370/329

(57) ABSTRACT

A network node (10) communicates with user equipments, UEs, in a cell served by the network node. The network node receives measurement reports from its UEs and obtains therefrom statistics (S1). The network node receives an interference overload indicator, IOI, from a neighboring network node having a neighboring cell (S2) that may prompt making the determination. The network node uses the statistics to determine whether transmissions in the cell are or will be a likely cause of interference to the neighboring cell (S3). The network node then determines whether to take action with respect to one or more of the UEs based on the determination of whether transmissions in the cell are or will be a likely cause of interference to the neighboring cell (S4).

### BACKGROUND

The technology pertains to wireless communications networks, and particularly, to coordinating inter-cell interference between cells.

In a typical cellular radio system, radio or wireless terminals (also known as mobile stations and/or user equipments (UEs)) communicate via a radio access network (RAN) to one or more core networks. The radio access network (RAN) covers a geographical area which is divided into cell areas, with each cell area being served by a base station, e.g., a radio base station (RBS), which in some networks may also be called, for example, a “NodeB” (UMTS) or “eNodeB” (LTE). A cell is a geographical area where radio coverage is provided by the radio base station equipment at a base station site. Each cell is identified by an identity within the local radio area, which is broadcast in the cell. The base stations communicate over the air interface operating on radio frequencies with the UEs within range of the base stations. In some radio access networks, several base stations may be connected (e.g., by landlines or microwave) to a radio network controller (RNC) or a base station controller (BSC). The radio network controller supervises and coordinates various activities of the plural base stations connected thereto. The radio network controllers are typically connected to one or more core networks.

Although 3GPP terminologies pertaining to LTE are used in the following for explanation purposes, this should not be seen as limiting the scope of the disclosed subject matter to only a particular 3GPP system like LTE. Other wireless systems, such as WCDMA, UMTS, WiMax, UMB, GSM and others may benefit from exploiting the ideas covered within this disclosure.

Modern and future wireless systems are expected to support bandwidth-hungry and high bit rate-demanding applications with even stricter requirements on throughput and quality of service (QoS). These expectations have motivated the use of multiple antennas at the transmitter and/or receiver side, more advanced receivers and receiving algorithms. and smarter radio resource management (RRM) techniques. The result has been an increase the system's throughput and capacity by manifolds, especially in the downlink.

Because the evolved Node B (eNB) in LTE (a radio base station) typically has more processing and transmit power as compared to a user equipment (UE) radio terminal (referred to simply as a UE), the uplink communication from UE to eNB is a more difficult challenge for researchers and system designers, especially in terms of “cell-edge throughput.” Enhanced uplink cell-edge performance means improved end-user experience. especially given increases in both quantity and required QoS for uplink traffic.

FIG. 1 illustrates a common uplink cell-edge interference scenario. The uplink transmission of UE2 in the right cell served by eNB2 is interfering with the uplink transmission from UE1 to its serving eNB1.

One way of enhancing the uplink performance is through RRM. From a high level perspective, RRM-related schemes affecting the uplink performance may be divided in two groups. The first is fast RRM including link adaptation, power control, and scheduling. Fast RRM techniques operate on a transmission time interval (TTI) basis, i.e., they take decisions every millisecond. The second is slow RRM that includes inter-cell interference coordination (ICIC) schemes. Slow RRM techniques operate on a slower time scale (e.g., 20 milliseconds or longer) because they require exchanging information between different eNBs stations over the X2 interface in LTE. In X2-based ICIC, the coordination may occur between cells belonging to different eNBs and between cells belonging to the same eNB.

An ICIC scheme may include Fractional Frequency Reuse (FFR) which is now explained with reference to FIG. 2. In FFR, UEs classified as high-interfering UEs (HIU) may be scheduled only on a specific part of the radio frequency spectrum referred to as a high interference region (HIR). FIG. 2 illustrates the FFR concept with a special example case of non-overlapping lints between three cells. In FIG. 2, the size of the HIRs are equal, and the HIRs are not overlapping. This is mainly for the purpose of illustration. However, ICIC schemes are expected to control the size of the HIRs and whether they are allowed to overlap in specific cells. HIUs in cell 1 may only be scheduled over HIRI, but non-HlUs may be scheduled to transmit using radio resources anywhere in the spectrum, including in the HIR. By avoiding scheduling cell-edge UEs on the same part of the spectrum in neighboring cells, inter-cell interference experienced by the cell-edge UEs is expected to significantly decrease, leading to an increase in the Signal to Interference and Noise Ratio (SINR) experienced by these cell-edge UEs.

An ICIC scheme, and in particular X2-based ICIC, endeavors to dynamically coordinate the allocation of these HIRs between different cells without the need for manual cell planning, while taking into account the traffic change in different cells over time. In performing X2-based ICIC, the 3GPP standard supports two parameters: a high interference indicator (HII) and an interference overload indicator (IOI). The HII indicates the occurrence of high interference sensitivity on specific physical resource blocks (PRB) (e.g., the eNB will schedule cell edge UEs transmitting with maximum power) using a bitmap (0's and 1's) and is sent to one or several specific cells. As such, HII is a proactive parameter indicating that high interference will occur on a particular PRB, and HII may be used so that a cell informs other cells which HIR the cell is using. The IOI indicates the interference level (high, medium, or low) experienced by the cell on specific PRBs. Given that a cell does not know where the interference it is suffering from originates, that cell broadcasts the IOI to its neighboring cells. In other words, the IOI is a reactive parameter used by a cell to inform other cells whether that cell is experiencing high interference.

One of the main challenges in applying ICIC schemes is the decentralized architecture in many modem wireless systems such as LTE, WiMax, etc. This decentralization makes it challenging for a certain radio network node like an eNB to know which cell(s) to cooperate with and which cell(s) to ignore. For instance, when it comes to a reactive approach to ICIC using IOI, the IOI is not cell-specific. In other words, the cell sending an interference-related X2 message does not specify to which cell it is sending the IOI because the sending cell does not know the UEs of which other cell(s) are interfering with it. As such, it is not possible to specify in advance which cells should react to this IOI and which cells should ignore it. Thus, it is desirable to provide a scheme that allows each cell receiving an IOI to quickly and efficiently decide whether it should ignore a received IOI or react to it, and in thereby, avoid triggering unnecessary action at unaffected or less affected cells.

Furthermore, as the same IOI is sent to all neighboring cells, those neighboring cells will likely take a similar action based on the received IOI. But different cells will likely cause a different amount or degree of interference at different neighboring cells. As a result, it is desirable to allow each cell receiving an IOI to be able to determine “how much” it should react to a received IOI. In other words, a cell may intelligently and dynamically determine which interference messages to ignore and which to react to, and in that case, by how much.

The technology in this application solves these and other problems using techniques to facilitate cooperation among neighboring cells through sending and/or receiving interference overload indications.

### SUMMARY

A first aspect of the technology includes a network node for interference coordination in a wireless communications network, the network node communicating with user equipments. UEs, in a cell served by the network node. The network node includes a communication unit to receive an interference overload indicator, IOI, from a neighboring network node associated with the neighboring cell. An interference determination unit is configured to determine, whether transmissions in the cell are or will be a likely cause of interference to a neighboring cell. A determination unit is configured to determine, in response to the received IOI, whether to take action with respect to one or more of the UEs in the cell based on the determination of whether transmissions in the cell are or will be a likely cause of interference to the neighboring cell. In an example implementation. the network node is a base station.

A second aspect of the technology includes a method for interference coordination in a wireless communications network including a network node communicating with user equipments (UEs) in a cell served by the network node. The method includes the network node performing the following steps: receiving an interference overload indicator, IOI, from a neighboring network node having a neighboring cell (receipt of the IOI may trigger initiation of the method);determining whether transmissions in the cell are or will be a likely cause of interference to a neighboring cell; and determining, in response to the received IOI, whether to take action with respect to one or more of the UEs based on the determination of whether transmissions in the cell are or will be a likely cause of interference to the neighboring cell.

In example implementations, the step of determining whether to take action includes determining whether to change a physical resource allocation in the cell. For example, determining whether to change a physical resource allocation in the cell may include changing scheduling of transmissions of one or more of the UEs previously scheduled for a high interference region, HIR, of the cell.

One example embodiment determines an extent to which the transmissions in the cell caused interference to the neighboring cell and an amount to change transmissions of one or more of the UEs based on the determined extent to which the transmissions in the cell caused or will likely cause interference to the neighboring cell. If transmissions in the cell are not or will not be a likely cause of significant interference to the neighboring cell, then not taking action with regard to transmissions of one or more of the UEs. Alternatively, if transmissions in the cell are not or will not be a likely cause of significant interference to the neighboring cell, then taking a smaller action with regard to transmissions of one or more of the UEs than if transmissions in the cell are or will be a likely cause of significant interference to the neighboring cell.

Measurements, e.g., signal quality measurements, may be received from the UEs in the cell. Statistics may be obtained, based on the received UE measurements, about one or more neighbor cells in which transmissions in the cell are or will be a likely cause of interference. As one example, received UE measurements may be based on one or more predetermined handover events. A threshold may be associated with the one or more predetermined handover events determines what level of interference is considered as high interference.

The technology described above provides multiple advantages. For example, the technology dynamically allows different cells to selectively take different actions upon reception of an IOI measure based on that cell's assessment of its affect on that IOI measure. Because the technology dynamically identifies which cells should coordinate with each other with regard to likely inter-cell interference, the amount of inter-cell signaling and the number of cells that need to take some type of ameliorative action are reduced. In turn, the chance of having a “ripple effect” in the system where all or a large number of cells receiving inter-cell information take unnecessary processing and possibly unnecessary ameliorative action is reduced.

Another advantage is that when UEs change location and their likely interference with neighbor cells changes, these changes are dynamically and easily taken into account. The technology may also be implemented in a distributed way so that a centralized or master node is not required.

### BRIEF DESCRIPTION OF THE DRAWINGS

FIG. 1 illustrates a common uplink cell-edge interference scenario;

FIG. 2 illustrates a bandwidth scheduling for high interference region (HIR) parts of the radio spectrum;

FIG. 3 is a non-limiting example function block diagram of an LTE cellular communications network;

FIG. 4 is a graph that shows handover measurement triggering event A3 that may be used as a new ICIC-based A3 event for the purpose of interference measurements;

FIG. 5 is an example diagram showing multiple neighboring cells with cell border UEs in cell A;

FIG. 6 is a flowchart illustrating non-limiting, example procedures for a network node in accordance with an example embodiment; and

FIG. 7 is non-limiting example function block diagram of a network node in accordance with an example embodiment.

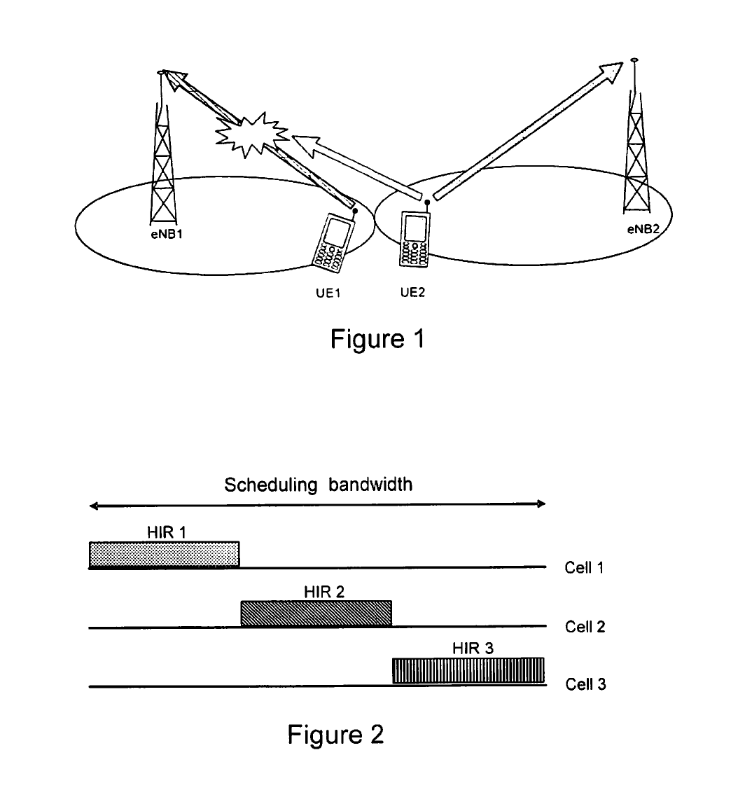

### DETAILED DESCRIPTION

In the following description, for purposes of explanation and not limitation, specific details are set forth such as particular architectures, interfaces, techniques, etc. However, it will be apparent to those skilled in the art that the technology described here may be practiced in other embodiments that depart from these specific details. That is, those skilled in the art will be able to devise various arrangements which, although not explicitly described or shown herein, embody the principles of the technology described and are included within its spirit and scope. In some instances, detailed descriptions of well-known devices, circuits, and methods are omitted so as not to obscure the description with unnecessary detail. All statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein may represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “computer”, “processor” or “controller” may be provided through the use of dedicated hardware as well as hardware capable of executing software in the form of coded instructions stored on computer readable medium. A computer is generally understood to comprise one or more processors and/or controllers, and the terms computer and processor may be employed interchangeably herein. When provided by a computer or processor, the functions may be provided by a single dedicated computer or processor, by a single shared computer or processor, or by a plurality of individual computers or processors, some of which may be shared or distributed. Such functions are to be understood as being computer-implemented and thus machine-implemented. Moreover, use of the term “processor” or “controller” shall also be construed to refer to other hardware capable of performing such functions and/or executing software, and may include, without limitation, digital signal processor (DSP) hardware, reduced instruction set processor, hardware (e.g., digital or analog) circuitry, and (where appropriate) state machines capable of performing such functions.

The technology described below addresses and solves issues described in the background. Each base station (cell) dynamically determines which neighboring cell(s) its served UEs will likely interfere with for scheduled UE transmissions and the likelihood (e.g., expressed as a percentage or probability) that its UEs will actually interfere with those scheduled transmissions. This information may be based, for example, on long-term measures that take into account the speed of the ICIC process. Based on the likelihood of interference, the base station (cell) may estimate how much it caused a neighbor cell to send an indicator, e.g., an IOI, indicating high interference or higher interference on one or more particular uplink radio resources, e.g., physical resource blocks (PRBs). And based on this, the base station (cell) receiving the indicator, e.g., IOI, may decide whether it should take action to reduce the contribution to that indicator, e.g., IOI, likely caused by or to be caused by the base station (cell) and/or its UEs, and if so, what amount of an action base station (cell) should take. For example, the base station (cell) receiving the indicator, e.g., IOI, may avoid scheduling a particular UE transmission on a particular radio resource, e.g., an HIU on one or more PRBs, that impacts the cell that sent the indicator, e.g., IOI.

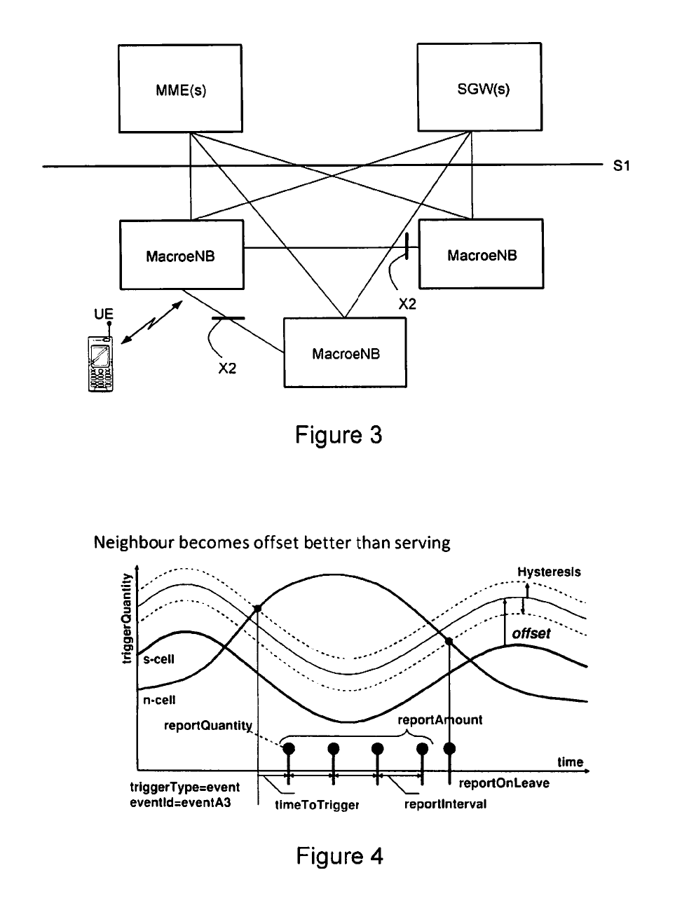

Although the technology may be used in any radio access network (RAN), single-RAT or multi-RAT, for illustration purposes 3GPP LTE examples are provided. In this regard, FIG. 3 shows an example diagram of an LTE-based communications system. The core network nodes include one or more Mobility Management Entities (MMEs), a key control node for the LTE access network, and one or more Serving Gateways (SGWs) which route and forward user data packets while and acting as a mobility anchor. They communicate with base stations, referred to in LTE as eNBs, over an S1 interface. The eNBs may include macro and micro eNBs that communicate over an X2 interface. The term “cell” is used below to describe both a geographic radio coverage area and an eNB entity that provides radio access network service in that area. The cells serve and communicate with one or more UEs over the radio interface.

In the following non-limiting description, which is in an example LTE context, the LTE Interference Overload Indicator (IOI) is used as an example of interference overload information. In a decentralized system like LTE without a central node coordinating decisions, it is advantageous for a cell to selectively determine the appropriate neighbor cells to coordinate with. By determining that it should only selectively react to IOI messages received from neighbor cells, unnecessary interference avoidance actions are avoided. Taking unnecessary actions could lead to a “ripple effect” in the network, i.e., a ping-pong effect where one unnecessary action based on coordination leads to another unnecessary action.

Initially, a cell obtains measurements from its UEs, e.g., signal quality measurements. It may then use these measurements in order to obtain statistics and/or other information about the neighbor cells that uplink UE transmissions that the cell has scheduled are interfering with or will likely interfere with. One example way to obtain measurements from its UEs is using one or more existing handover events. Consider for example the existing handover measurement triggering event A3 shown in FIG. 4. A new ICIC-based A3 event for the purpose of interference measurements does not result in changes to the triggering event shown in FIG. 4. According to an exemplary embodiment, an ICIC-based A3 event has a more aggressive configuration as compared to a handover-based A3 event, e.g., the ICIC-based event is triggered earlier than the handover-based event in order to start coordinating UEs before they reach the handover phase. The parameters that may be configured to include, e.g., the time to trigger (TTT), offset, and hysteresis. Each cell may obtain measurements from its served (e.g., RRC-connected) UEs identifying those cell(s) for which the UE uplink transmissions are likely to cause the most interference. By selectively setting the A3 event threshold, the serving cell may control what level of interference is considered as sufficiently high interference. The cell may stores information from UE measurement reports in memory, and in the process, may also create and store a list of cells that its UEs are or will be likely cause of interference. That list may also include a corresponding amount or degree of likely interference for each listed cell and the particular radio resource(s) likely affected.

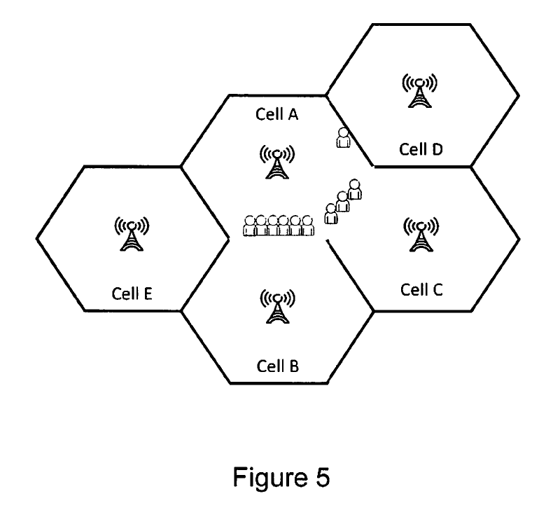

Consider the example illustrated in FIG. 5 showing UEs of cells B, C, and D that cause or are likely to cause uplink (UL) interference at cell A. In this example, there are ten cell-edge UEs or HIUs interfering with cell A in the uplink or on uplink radio resources. Six of these UEs or HIUs are in cell B, three are in cell C, and one is in cell D. However, cell A does not know this information. As such, Cell A is not able to specify to which cells it wants to send an KN. Sending UE interference information from cells B, C, and D to cell A may require significant signaling, particularly when the positions of the UEs are not fixed.

Instead of relying upon the neighboring cells B, C, and D to send UE interference information to cell A, the neighboring cells B, C, and D may take appropriate action or inaction based on the statistical determination each of the neighboring cells makes using its received UE measurement information as to whether transmissions in its cell will likely be cause of interference to cell A.

In addition, upon receiving an IOI from cell A, cell B knows that it has a high number of UEs scheduled on UL radio resources, e.g., UL PRBs, where the POI from cell A indicates high interference. Cell B may then conclude that it is a significant factor or cause behind cell A generating and sending the IOI cell B received.

As a result of the statistical based determination (and optionally at the prompting of a received KM from cell A), cell B determines that it should take action and change its HIR allocation or other radio resource allocation(s). On the other hand, cells C and D may determine not to take any action as a result of their own statistical based determinations. For example, cells C and D may determine from their UE measurement based statistics that their respective HIUs were or are not scheduled on the region or radio resources that cell A's MI identifies as interfered with. Another example is that cells C and D determine that too few HIUs were/are scheduled over cell A's HIR.

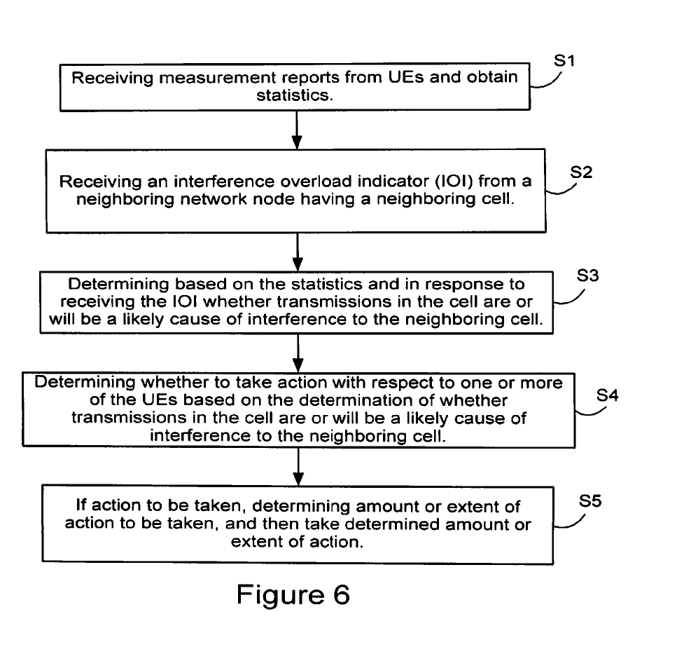

FIG. 6 is a flowchart illustrating non-limiting, example procedures for a network node in accordance with a first example embodiment. The method permits interference coordination in a wireless communications network including a network node communicating with user equipments (UEs) in a cell served by the network node. The network node receives measurement reports from its UEs (step S1). From these UE measurements, the network node obtains statistics about neighbor cells it will interfere with (step S1). The network node also receives an interference overload indicator, IOI, from a neighboring network node having a neighboring cell (step S2). From those statistics, the network node determines whether transmissions in the cell are or will be a likely cause of interference to a neighboring cell (step S3). Prompted by the received IOI, the node determines whether to take action with respect to one or more of the UEs based on the determination of whether transmissions in the cell are or will be a likely cause of interference to the neighboring cell (step S4). If action to be taken, the network node may determine an amount or an extent of action to be taken, and then takes the determined amount or extent of action (step S5).

In non-limiting example implementations, determining whether to take action may include determining whether to change a physical radio resource allocation in some or all of the cell. For example, the action make include changing scheduling of transmissions of one or more of the UEs previously scheduled on a high interference region, HIR, of the cell.

In another non-limiting example embodiment, the network node determines an extent to which the transmissions in its cell likely caused or will likely cause interference to a neighboring cell and an amount to change transmissions of one or more of the UEs based on the determined extent to which the transmissions in the cell likely caused or will likely cause interference to the neighboring cell. If transmissions in the cell are not or will not be a likely cause of significant interference to the neighboring cell, then not taking action with regard to transmissions of one or more of the UEs. Alternatively, if transmissions in the cell are not or will not be a likely cause of significant interference to the neighboring cell, then taking a smaller action with regard to transmissions of one or more of the UEs than if transmissions in the cell are or will be a likely cause of significant interference to the neighboring cell.

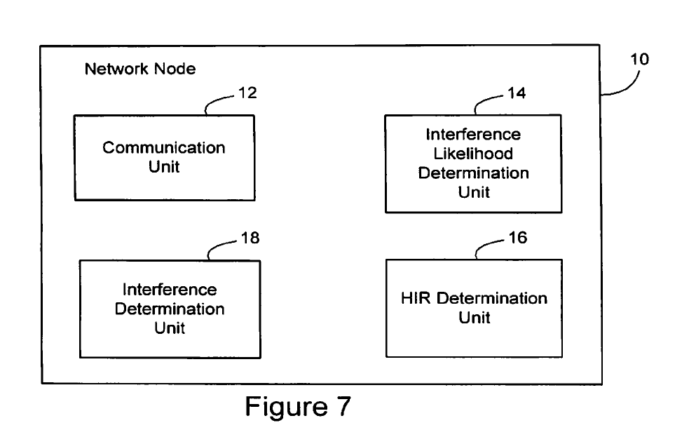

FIG. 7 is non-limiting example function block diagram of a network node 10 in accordance with the example first embodiment. The network node 10 may include a communication unit 12, an interference likelihood determination unit 14, an HIR determination unit 16, and an interference determination unit 18. The communication unit 12 may communicate with UEs over wireless channels, for example, to receive measurement reports from the UEs, e.g., signal quality measurement information. The communication unit 12 may also communicate with other similar network nodes 10 including other cells over the X2 interface for example to exchange IOI or similar information.

The interference determination unit 18 may determine whether its cell and/or its UEs are experiencing too much interference, i.e., whether the cell is suffering from interference overload. The interference determination unit 18 may directly measure interference and/or it may determine interference from UE measurement reports. The HIR determination unit 16 may determine or choose its HIR based its interference determinations and optionally in response to IOI information received from other cells.

FIG. 7 provides a logical view of the network node and the units included therein. It is not strictly necessary that each unit be implemented as physically separate modules. Some or all units may be combined in a physical module. Also, the units need not be implemented strictly in hardware. It is envisioned that the units may be implemented through a combination of hardware and software. For example, the network node may include one or more central processing units executing program instructions stored in a non-transitory storage medium or in firmware to perform the functions of the units.

The technology described above provides multiple advantages. For example, the technology dynamically allows different cells to selectively take different actions upon reception of an IOI measure based on that cell's assessment of its affect on that IOI measure. Because the technology dynamically identifies which cells should coordinate with each other with regard to likely inter-cell interference, the amount of inter-cell signaling and the number of cells that need to take some type of ameliorative action are reduced. In turn, the chance of having a “ripple effect” in the system where all or a large number of cells receiving inter-cell information take unnecessary processing and possibly unnecessary ameliorative action is reduced. Another advantage is that when UEs change location and their likely interference with neighbor cells changes, these changes are dynamically and easily taken into account. The technology may also be implemented in a distributed way so that a centralized or master node is not required.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology described here, for it to be encompassed by the present claims. No claim is intended to invoke paragraph 6 of 35 USC §112 unless the words “means for” or “step for” are used. Furthermore, no embodiment, feature, component, or step in this specification is intended to be dedicated to the public regardless of whether the embodiment, feature, component, or step is recited in the claims.

1-22. (canceled)

23. A network node for interference coordination in a wireless communications network, the network node operative to communicate with user equipment UE in a first cell served by the network node, the network node comprising:
an interference determination circuit configured to determine whether transmissions in the first cell are, or will be, a likely cause of interference to a neighboring cell;
a communication circuit configured to receive an interference overload indicator (IOI) from a neighboring network node having a neighboring cell;
a determination circuit configured, in response to reception of the IOI, to determine whether to take action with respect to one or more of the UEs in the first cell based on the determination of whether transmissions in the first cell are, or will be, a likely cause of interference to the neighboring cell.

24. The network node of claim 23, wherein the determination circuit is configured to determine whether to change a physical resource allocation in the first cell.

25. The network node of claim 24, wherein the determination circuit is configured to change scheduling of transmissions of one or more of the UEs previously scheduled for a high interference region of the first cell.

26. The network node of claim 23:
wherein the interference determination circuit is configured to determine an extent to which the transmissions in the first cell likely caused, or will likely cause, interference to the neighboring cell;
wherein the determination circuit is configured to determine an amount to change transmissions of one or more of the UEs based on the determined extent to which the transmissions in the first cell likely caused, or will likely cause, interference to the neighboring cell.

27. The network node of claim 23, wherein, in response to the interference determination circuit determining that transmissions in the first cell are not, or will not be, a likely cause of significant interference to the neighboring cell, the determination circuit is configured to not to take action with regard to transmissions of one or more of the UEs.

28. The network node of claim 23, wherein in response to the interference determination circuit determining that transmissions in the first cell are not, or will not be, a likely cause of significant interference to the neighboring cell, the determination circuit is configured to take a smaller action with regard to transmissions of one or more of the UEs than if transmissions in the first cell are, or will be, a likely cause of significant interference to the neighboring cell.

29. The network node of claim 23, wherein the communications circuit is configured to receive measurements from the UEs in the first cell.

30. The network node of claim 29, wherein the interference determination circuit is configured to obtain statistics about one or more neighbor cells in which transmissions in the cell are, or will be, a likely cause of interference based on the received UE measurements.

31. The network node of claim 29, wherein the received UE measurements are based on one or more predetermined handover events.

32. The network node of claim 31, wherein a threshold associated with the one or more predetermined handover events determines what level of interference is considered as high interference.

33. The network node of claim 23, wherein the network node is a base station.

34. A method for interference coordination in a wireless communications network including a network node communicating with user equipment (UE) in a first cell served by the network node, the method comprising network node:
receiving an interference overload indicator (IOI) from a neighboring network node having a neighboring cell;
determining whether transmissions in the first cell are, or will be, a likely cause of interference to a neighboring cell;
determining, in response to the receiving the IOI, whether to take action with respect to one or more of the UEs based on the determination of whether transmissions in the first cell are, or will be, a likely cause of interference to the neighboring cell.

35. The method of claim 34, wherein the determining whether to take action includes determining whether to change a physical resource allocation in the first cell.

36. The method of claim 35, wherein the determining whether to change a physical resource allocation in the first cell includes changing scheduling of transmissions of one or more of the UEs previously scheduled for a high interference region of the first cell.

37. The method of claim 34, further comprising:
determining an extent to which the transmissions in the first cell likely caused, or will likely cause, interference to the neighboring cell;
determining an amount to change transmissions of one or more of the UEs based on the determined extent to which the transmissions in the first cell likely caused, or will likely cause, interference to the neighboring cell.

38. The method of claim 34, wherein in response to determining that transmissions in the first cell are not, or will not be, a likely cause of significant interference to the neighboring cell, not taking action with regard to transmissions of one or more of the UEs.

39. The method of claim 34, wherein in response to determining that transmissions in the first cell are not, or will not be, a likely cause of significant interference to the neighboring cell, taking a smaller action with regard to transmissions of one or more of the UEs than if transmissions in the first cell are, or will be, a likely cause of significant interference to the neighboring cell.

40. The method of claim 34, further comprising receiving measurements from the UEs in the first cell.

41. The method of claim 40, further comprising obtaining statistics about one or more neighbor cells in which transmissions in the first cell are, or will be, a likely cause of interference to the neighboring cell based on the received UE measurements.

42. The method of claim 40, wherein the received measurements are based on one or more predetermined handover events.

43. The method of claim 42, wherein a threshold associated with the one or more predetermined handover events determines what level of interference is considered as high interference.

44. The method of claim 34, wherein the network node is a base station.
